(19) United States
(12) Patent Application Publication
(10) Pub. No.: US 2018/0163408 A1
(43) Pub. Date: Jun. 14, 2018

(54) APPARATUS FOR INSTALLING ALIGNED ELEMENTS

(71) Applicant: Inventive Media, Inc., Norwalk, CT (US)

(72) Inventor: Nathaniel Hull Acker, JR., Norwalk, CT (US)

(21) Appl. No.: 15/834,307

(22) Filed: Dec. 7, 2017

Related U.S. Application Data
(60) Provisional application No. 62/431,849, filed on Dec. 9, 2016.

(51) Int. Cl. E04D 15/02; G01C 9/18; G01B 5/25

(52) U.S. Cl. CPC E04D 15/025; G01B 5/25; G01C 9/18

(57) ABSTRACT

The present disclosure relates to an apparatus for installing aligned elements, and methods of use. An apparatus can include: an aligning member; a first support configured to support the aligning member at a first location of the aligning member; and a first mount including a mounting member configured to couple the first mount to a structural surface and a first support positioner configured to slidably receive and selectively vertically position the first support relative to the surface, thereby vertically positioning the aligning member.

### BACKGROUND

### 1. Technical Field

The present disclosure relates to embodiments of an apparatus for installing aligned elements, and related methods of use.

### 2. Background Art

To withstand the effects of weather and material degradation, roofs and/or other surfaces on the exterior of a building may include environmentally resistant elements. As examples, such elements may include shingles, tiles, and/or other components which contact and are installed upon exposed surfaces of the building. In many cases, these elements are designed for substantial alignment with each other and may be installed in a series of successive overlapping or non-overlapping rows. Conventionally, such elements may be installed on a building manually with the aid of one or more tools for placing, aligning, and attaching each shingle at a site of installation.

Manually installing environmentally resistant elements onto the surface of a building can be time-consuming and expensive. In particular, the process may be prone to errors stemming from misalignment, spacing irregularities, etc. To address these concerns, aligned elements may be installed row-by-row with the aid of removable fixtures temporarily coupled to the surface of the building. During use, such fixtures are typically aligned, set, and installed before a corresponding single row of aligned elements is installed. After a single, predetermined row of aligned elements has been installed, the user can move the fixture to another position, where it must be separately reattached to the surface of the building before another single row of aligned elements can be installed.

### SUMMARY

The illustrative aspects of the present disclosure are designed to solve the problems herein described and/or other problems not discussed.

A first aspect of the present disclosure provides an apparatus including: a aligning member; a first support configured to support the aligning member at a first location of the aligning member; and a first mount including a mounting member configured to couple the first mount to a structural surface and a first support positioner configured to slidably receive and selectively vertically position the first support relative to the surface, thereby vertically positioning the aligning member.

A second aspect of the present disclosure provides an apparatus including: a aligning member having opposing ends; a pair of supports each configured to support the aligning member at one of the opposing ends thereof; and a pair of mounts each including a mounting member configured to couple the mount to a structural surface and a support positioner configured to slidably receive and selectively vertically position one of the pair of supports relative to the surface, thereby vertically positioning the aligning member.

A third aspect of the present disclosure provides an apparatus including: a aligning member having opposing ends, the opposing ends each configured to engage an adjacent aligning member; a level sensor coupled to the aligning member, wherein the level sensor indicates a planar orientation of the aligning member; a pair of supports each configured to support the aligning member at one of the opposing ends thereof; and a pair of mounts each including a mounting member configured to couple the mount to a structural surface and a support positioner configured to slidably receive and selectively vertically position one of the pair of supports relative to the surface, thereby vertically positioning the aligning member.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a plan view of an apparatus according to embodiments of the disclosure.

FIG. 2 shows a side view of a mount for an apparatus according to embodiments of the disclosure.

FIG. 3 shows a side view of a mount for an apparatus according to further embodiments of the disclosure.

FIG. 4 shows a side view of an apparatus according to embodiments of the disclosure.

FIG. 5 shows a plan view of an apparatus according to further embodiments of the disclosure.

FIG. 6 shows a perspective view of an apparatus according to embodiments of the disclosure.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

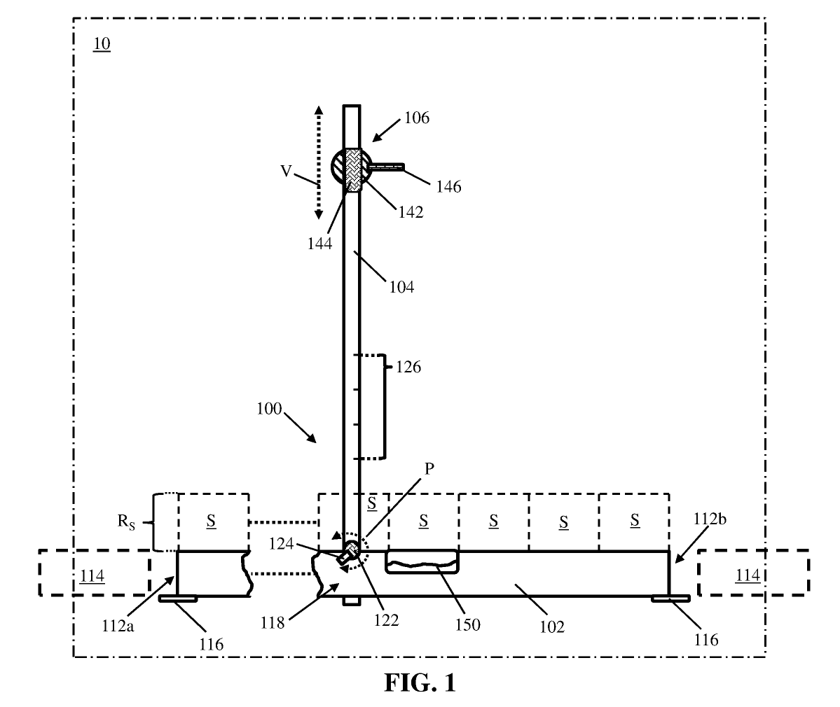

Referring to FIG. 1, a user may install a series of elements onto a surface 10 with embodiments of an apparatus 100. As used herein, an element being installed on surface 10 refers to the element being nailed, adhered, melted, and/or otherwise fastened directly to surface 10 and/or other components thereon (e.g., previously installed elements). In the context of apparatus 100, installing refers to the process of placing a bottom edge of one or more aligned elements S in alignment with a top edge or a bottom edge of an alignming member 102, discussed herein, for fastening to surface 10. Surface 10 and apparatus 100 are depicted in a top-down plan view in FIG. 1. Surface 10 may include any surface of a building which may be covered by aligned. Elements S may include any structure to be installed on the surface, e.g., of a building, surfaces of a roof, wall, or other surface. Examples of aligned elements can include siding, roof shingles, tiles, etc. Embodiments of apparatus 100 can be used to install multiple rows Rₛ of aligned elements S (shown in phantom) at respective positions, without reattaching elements of apparatus 100 to different portions of surface 10 for each row Rₛ, as discussed herein.

Apparatus 100 can include an aligning member 102 which extends longitudinally (e.g., in a horizontal direction) along surface 10. Aligning member 102 can be shaped to align a particular row Rₛ of aligned elements S with a desired site of installation on surface 10. Apparatus 100 can also include one or more supports 104 which mechanically support and connect to aligning member 102, as described herein. As illustrated in FIG. 1, support 104 may extend vertically and in a substantially perpendicular direction relative to aligning member 102. To move aligning member 102 vertically across surface 10 and between successive rows Rₛ of aligned elements S, apparatus 100 can include a mount 106 positioned on surface 10 and slidably mechanically coupled to support 104. Mount 106 may be coupled to surface 10 at a fixed position, such that support 104 slides relative to mount 106 substantially along one or more predetermined directions, e.g., the direction of reference arrow V. Mount 106 can be structured to inhibit movement of support 104 in other directions, e.g., horizontally across, away from, and/or toward surface 10. During operation, a user of apparatus 100 can move support 104 relative to mount 106, thereby vertically adjusting the position of aligning member 102. At a selected position, a user can install one row Rₛ of aligned elements S with aligning member 102 without aligning member 102 being attached to surface 10. That is, embodiments of apparatus 100 can operate without separately coupling aligning member 102 to surface 10 through fasteners, adhesives, and/or other elements for separately holding aligning member 102 in a fixed position relative to surface 10. After row Rₛ of aligned elements S has been installed, the user can vertically adjust support 104 to move aligning member 102 to a new position and install at least one additional row Rₛ of aligned elements S. Depending on the length of support(s) 104, a large number of rows (e.g., five rows, ten rows, fifteen rows, or more) can be installed without re-mounting mount 106 and/or repositioning apparatus 100 elsewhere on surface 10.

Aligning member 102 can extend horizontally between two opposing ends 112a, 112b. A portion of aligning member 102 and row Rₛ of aligned elements S is shown with a broken line to indicate an indeterminate length. Aligning member 102 may include a relatively stiff material, such as but not limited to a metal, metal alloy, and/or other materials such as wood and/or one or more impact-resistant plastics (e.g., fluorinated ethylene propylene (“FEP”), polystyrene, ethylene tetrafluroroethylene, and/or other substantially inflexible plastics). During manufacture, a bulk element of such material can be obtained and cut to size to yield a predetermined length between opposing ends 112, 112b to accommodate one row Rₛ of aligned elements S. Aligning member 102 can be a modular component structured for use with at least one additional apparatus 100 having, e.g., an adjacent aligning member 114 which may be substantially horizontally aligned with aligning member 102. In an example, aligning member 102 can have a horizontal length of approximately eight feet between opposing ends 112a, 112b. As discussed elsewhere herein, aligning member 102 can include coupling components 116 at each end 112, 112b to join aligning member 102 to aligning member(s) 114 of an adjacent apparatus. Multiple apparatuses 100 can thus be used together to install one row Rₛ of aligned elements S having a greater horizontal length than one aligning member 102.

Support 104 can be mechanically coupled to a first location 118 of aligning member 102, such that support 104 extends substantially perpendicularly relative to aligning member 102. As discussed in detail elsewhere herein, multiple supports 104 may be used in other embodiments of apparatus 100. First location 118 can be positioned at an intermediate position on aligning member 102, e.g., approximately midway between first and second ends 112a, 112b of aligning member 102. In an embodiment, support 104 can be affixedly coupled to aligning member 102 through any currently-known or later-developed type of fixed joint for preventing movement of support 104 in any direction relative to aligning member 102. In these situations, support 104 can be coupled to aligning member 102 through, e.g., a weld bond, one or more fixed fasteners (bolts, screws rivets, etc.), dovetailed members, etc. In other embodiments, support 104 can be pivotably coupled to aligning member 102 through a pivotable coupling 122. Pivotable coupling 122 can include any currently-known or later developed instrument for preventing translational movement of support 104 relative to aligning member 102, while permitting at least limited rotational movement of support member 104 about aligning member 102. As shown, pivotable coupling 122 can allow movement substantially along the direction of arrow P to provide angular adjustment of aligning member 102. Pivotable coupling 122 can thus permit a user to adjust aligning member 102 such that Rₛ of aligned elements S may be installed at a desired position and/or angular orientation. Pivotable coupling 122 can include any currently-known or later developed instrument for permitting rotation of support 104 relative to aligning member 102 along line P, e.g., a hinge, flexible brace, a rotatable joint, a pivot bearing, etc., which may be adjusted, e.g., by the use of a threaded fastener selector, application of force by a user to change the position and/or orientation of pivotable coupling 122, moving the position of a pin within a pivotable component which may be adjusted, etc.

Regardless of whether support 104 is coupled to aligning member 102 through pivotable coupling 122 or another type of coupling component, a removable coupler 124 may also connect aligning member 102 and/or pivotable coupling 122 to support 104. According to an example, removable coupler 124, e.g., one or more removable fasteners such as a pin, rivet, lock, etc. Removable coupler 124 can selectively be removed from apparatus 100 to structurally detach support 104 from aligning member 102, and thereafter reconnect support 104 to aligning member 102 at another location. In this manner, a user can adjust the position of support 104 relative to aligning member 102 to accommodate different buildings, surfaces 10, and/or differently sized or positioned rows Rₛ of aligned elements S. In still further examples, a user may adjust the number of supports 104 connected to aligning member 102, e.g., by adding more removable couplers 124 to aligning member 102 and connecting additional supports 104 and/or pivotable couplings 122 to aligning member 102 through removable couplers 124. Thus, apparatus 100 can be freely modified to include two or more supports 104 by attaching two or more respective removable couplers to various locations 118 of aligning member 102. It is thus understood that pivotable coupling 122 can be used together with one or more removable couplers 124, or that such components may be used separately and/or independently in various embodiments of apparatus 100.

Each support 104 can also include features for assisting a user in adjusting apparatus 100 to install each row Rₛ of aligned elements S. As shown, support 104 can include a plurality of markers 126 for identifying a desired displacement between each row Rₛ of aligned elements S. The separation between each marker 126 on support 104 need not correspond with the vertical dimension of each element S, e.g., because some rows Rₛ of aligned elements S may overlap or otherwise be positioned on top of other rows Rₛ of aligned elements S. During operation, a user can move support 104 relative to surface 10 by predetermined increments shown through markers 126 to install successive rows Rₛ of aligned elements S without the need for a separate measurement or alignment device, and without moving mount 106 to another position on surface 10.

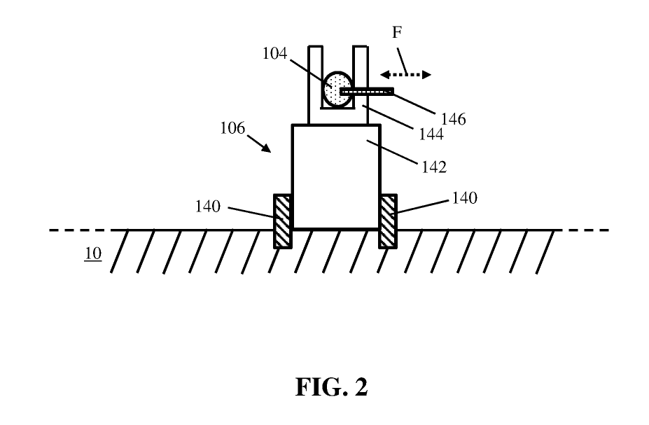

Referring to FIG. 2, mount 106 and components thereof are shown in detail to illustrate operational details of apparatus 100 (FIG. 1). Mount 106 can be positioned vertically distal relative to aligning member 102 (FIG. 1) along surface 10, and may engage or otherwise receive a portion of support 104 as further discussed herein. As shown, mount 106 can be disposed on surface 10 at a fixed position such that support 104 engages mount 106 above surface 10. During operation, a user can slide support 104 relative to mount 106 and surface 10 to successively install each row Rₛ of aligned elements S. As shown, mount 106 can include, e.g., one or more coupling components 140 (e.g., nails, bolts, threaded fasteners, rivets, adhesively bonded members, etc.) for engaging mount 106 to a predetermined location on surface 10. Each coupling component 140 can be mechanically connected to a mounting member 142 positioned on surface 10. Mounting member 142 can include, e.g., a post, plate, stand, base member, and/or other element(s) which can be structurally placed on and/or coupled to surface 10, e.g., through one or more coupling components 140 as discussed herein. Together, coupling components 140 and mounting member 142 can be removable from surface 10 such that mount 106 may be selectively attached, detached, and/or reattached to surface 10 as apparatus 100 is used to install multiple rows R_{S} of aligned elements S in different areas.

Mount 106 can also include a support positioner 144 positioned on mounting member 142, and which slidably receives and selectively vertically positions support 104 relative to surface 10. Sliding movement of support 104 relative to support positioner 144 of mount 106 can allow a user to adjust the position of aligning member 102 relative to surface 10 without separately attaching and detaching aligning member 102 to surface 10. Support positioner 144 can be embodied, e.g., as one or more mechanical coupling components for receiving support 104 therein, and which may permit axial movement of support 104, e.g., along vertical line V (FIG. 1). In an example, support positioner 144 may be shaped to include an interior shape and/or cross-section which permits directioned sliding movement of support 104 therein. In alternative embodiments, support positioner 144 can include, e.g., a shaft coupling, a groove coupling, a threaded aperture, and/or other slidable coupling elements through which support 104 may extend. In any event, support positioner 144 of mount 106 can remain stationary as support 104 moves relative to surface 10, thereby allowing users to adjust aligning member 102 during operation.

Mount 106 can also include one or more fasteners 146 for holding support 104 in a desired vertical position relative to surface 10 and mount 106. As shown, fastener 146 can include a pin for externally engaging support 104, e.g., at an outer surface or recessed element thereof. In alternative embodiments, fastener 146 can include, e.g., a rivet, screw, lock, brace, clamp, and/or other component for selectively prohibiting movement of support 104 relative to mount 106, e.g., along line V (FIG. 1). Fastener 146 can alternatively be embodied as any currently-known or later developed coupling component for selectively preventing movement of support 104 relative to mount 106.

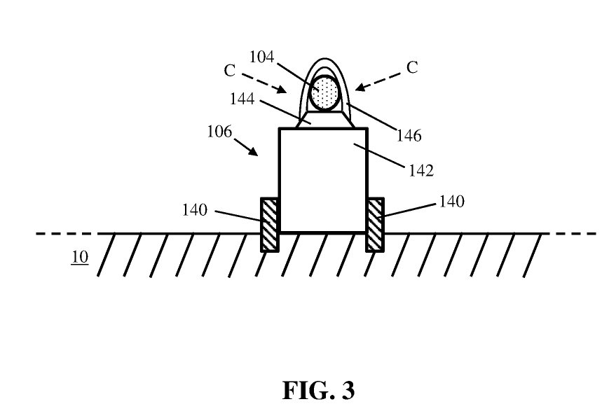

In an alternative embodiment depicted in FIG. 3, fastener(s) 146 may be structurally integrated with support positioner 144. For example, fastener 146 may be embodied as a “squeeze lock” or similar component formed from a flexible material, and shaped to impart an inwardly compressive force C against support 104 when at rest, thereby preventing movement of support 104 along the direction of arrow V (FIG. 1). When a user desires to move support 104 relative to mount 106, the user can flex, squeeze, stretch, or otherwise temporarily deform fastener 146 to change its interior surface area and thus remove the compressive force against support 104. When fastener 146 is temporarily deformed to remove friction against support 104, the user can vertically adjust support 104 relative to mount 106 and adjust the position of aligning member 102. Other currently known or later developed fasteners 146 configured to actively or passively engage support 104 may also be used to maintain a selected position of support 104. In any event, fastener 146 can allow a user to hold aligning member 102 in one position by preventing movement of support 104. To install another row Rₛ of aligned elements S, fastener 146 can be disengaged and/or removed to permit vertical movement of support 104 along line V.

Returning to FIG. 1, apparatus 100 can include a level sensor 150 to maintain a consistent angular orientation of aligning member 102 as each row Rₛ of aligned elements S is installed. Level sensor can include one or more currently-known or later developed instruments for indicating a planar orientation of aligning member 102. For example, level sensor 150 can include one or more currently-known or later developed elements for sensing a planar orientation of one or more components, e.g., a bubble/liquid level sensor, a capacitance-based level sensor, a sonic-based level sensor, an optical level sensor, etc. During operation, a user of apparatus 100 can read level sensor 150 to identify whether aligning member 102 is parallel with the ground before installing each element S. In the event that an angular orientation of elements S in row Rₛ is desired, level sensor 150 can be configured to indicate whether aligning member 102 extends along a particular angular orientation on surface 10. Where adjustment is needed, a user can move support 104 and/or pivotable coupling 122 before installing another row Rₛ of aligned elements S.

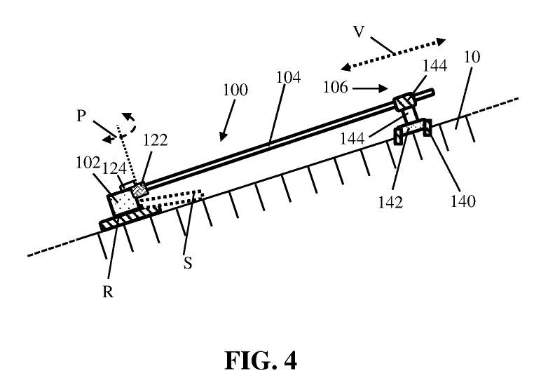

Turning to FIG. 4, a side view of apparatus 100 on surface 10 is shown to illustrate a method for installing aligned elements S. One or more rows of installed elements R may be present on surface 10. To install additional elements S, aligning member 102 can be positioned over and/or above installed element(s) R, e.g., by adjusting support 104 relative to mount 106 along the direction of line V. Successive rows of aligned elements S can thus be installed by moving aligning member 102 closer to, or further away from, or in another direction relative to mount 106 with support 104 after each row R_{S} (FIG. 1) of aligned elements S is installed. As shown, successive rows R_{S} of aligned elements S may be positioned to overlap with previously installed elements R when installed. In alternative embodiments, e.g., elements in the form of tiles, each successive row of aligned elements S may be positioned laterally adjacent to installed elements R without overlap therebetween.

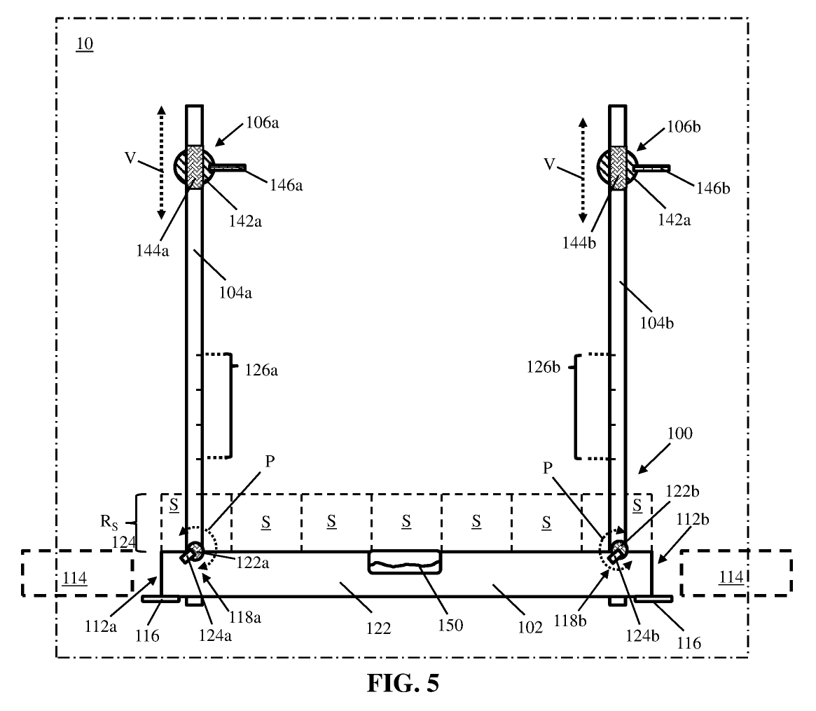

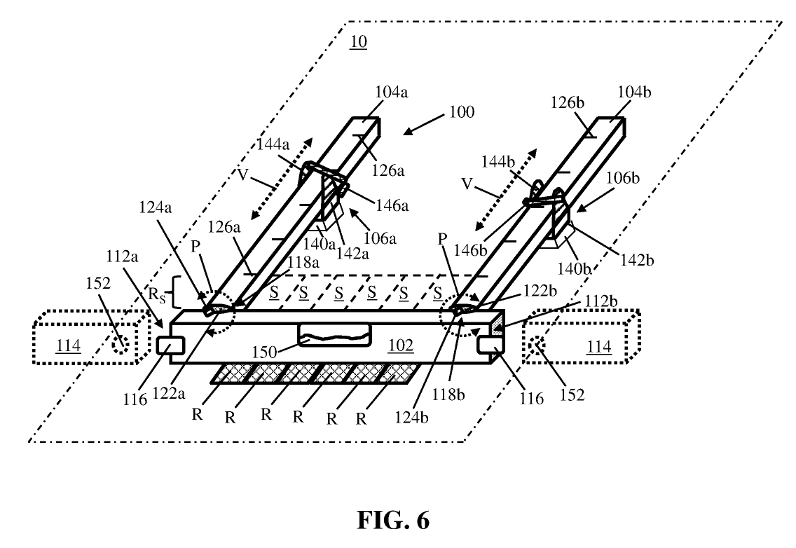

Referring to FIGS. 5-6 together, embodiments of the present disclosure can include apparatus 100 with multiple supports 104 and mounts 106. In particular, supports 104 may be provided as a pair 104a, 104b each coupled to respective locations 118a, 118b through pivotable couplings 122a, 122b and/or removable couplings 124a, 124b. Each location 118a, 118b can be positioned proximate an opposing end 112a, 112b of aligning member 102. As described elsewhere herein, each support 104a, 104b can engage a respective mount 106a, 106b positioned on surface 10. Each mount 106a, 106b can also include, e.g., coupling component(s) 140a, 140b, a mounting member 142b, 144b, a support positioner 144a, 144b for receiving support 104a, 104b therein, and/or respective fasteners 146a, 146b for selectively holding support(s) 104a, 104b in a desired position relative to surface 10. According to a further embodiment depicted in FIG. 6, each fastener 146a, 146b can include a spring clamp adjoined to support positioner 144a, 144b. At rest, fasteners 146a, 146b can inwardly compress support 104a, 104b, but may be temporarily opened to selectively permit movement of support 104a, 104b, e.g., along line V. The various embodiments and features of apparatus 100 discussed relative to FIGS. 1-3, including aligning member 102, mount(s) 106, etc., may also be included without modification where two or more supports 104 are used. Two supports 104a, 104b can be included to provide fine angular adjustment of aligning member 102 relative to surface 10. For example, where level sensor 150 indicates a non-parallel orientation of aligning member 102 relative to the horizontal axis of surface 10, a user can adjust multiple supports 104a, 104b of apparatus 100 to provide closer angular alignment with row Rₛ of aligned elements S. Furthermore, the use of multiple mounts 106a, 106b can allow each support 104a, 104b to more easily maintain each end 112a, 112b of aligning member 102 in a set position when installing aligned elements S. Pivotable couplings 122a, 122b can also enhance angular adjustment of aligning member 102 before installing row Rₛ of aligned elements S.

Referring to FIG. 6, aligning member 102 may be configured to engage adjacent aligning members 114, e.g., of an adjacent apparatus. Each adjacent aligning member 114 can include one or more apertures 152 for receiving coupling component 116 of aligning member 102 therein. Aligning member 102 of apparatus 100 can be removably attached to adjacent aligning members 114 by mechanically interconnecting coupling component(s) 116 with aperture(s) 152. In alternative embodiments, aligning member 102 can include aperture(s) 152, while adjacent aligning member(s) 114 can include coupling component(s) 116. In still other embodiments, aligning member 102 and adjacent aligning members 114 can include coupling components 116 in addition apertures 152. In an example, coupling component 116 may include a horizontally-extending dovetail protrusion shaped to engage aperture 152 in the form of a horizontally-extending dovetail slot. Coupling components 116 can also be embodied as any currently-known or later developed component for permitting selective attachment or removal of each coupling component 116 removal from aperture(s) 152, e.g., by including pins, magnets, locks, and/or other coupling components. To accommodate differently-sized rows Rₛ of aligned elements S, a varying number of aligning members 102, 114 can be structurally connected or disconnected to yield a desired length. In addition to providing a modular size, using multiple aligning members 102, 114 can reduce the risk of stress and/or structural deformation to each aligning member 102, 114 or apparatus 100 when a large number of aligned elements S are installed.

Embodiments of the present disclosure can provide multiple technical and commercial advantages, some of which are discussed herein by way of example. Embodiments of apparatus 100 can operate without separately mechanically coupling aligning member 102 to surface 10 when installing each row Rₛ of aligned elements S. Instead, a user can couple mount(s) 104 to surface 10 and adjust supports 104 to install multiple rows Rₛ of aligned elements S while mounts 106 remain in a single position. In addition, aligning member 102 can be closely angularly aligned with each row Rₛ of aligned elements S before installation, and/or adjusted easily by movement of supports 104. Embodiments of apparatus 100 can also reduce risk of human error during installation and thus may reduce installation time and costs.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

We claim:

1. An apparatus comprising:
an aligning member;
a first support configured to support the aligning member at a first location of the aligning member; and
a first mount including a mounting member configured to couple the first mount to a structural surface and a first support positioner configured to slidably receive and selectively vertically position the first support relative to the surface, thereby vertically positioning the aligning member.

2. The apparatus of claim 1, wherein the aligning member further includes a level sensor for indicating a planar orientation of the aligning member.

3. The apparatus of claim 1, further comprising:
a second support configured to support the aligning member at a second location of the aligning member; and
a second mount including a mounting member configured to couple the second mount to the structural surface and a second support positioner configured to slidably receive and selectively vertically position the second support relative to the surface, thereby vertically positioning the aligning member.

4. The apparatus of claim 1, wherein the first support positioner further includes a fastener configured to hold the first support member in a selected vertical position.

5. The apparatus of claim 1, wherein the first support is pivotably coupled to the aligning member at the first location.

6. The apparatus of claim 1, wherein a first end of the aligning member is configured to engage an adjacent aligning member.

7. The apparatus of claim 6, wherein the first end of the aligning member further includes a coupling component for removably attaching the adjacent aligning member to the aligning member.

8. The apparatus of claim 1, wherein the first support is removably coupled to the aligning member.

9. The apparatus of claim 1, wherein the first support further includes a plurality of markers configured to indicate a displacement between successive rows of aligned elements.

10. An apparatus comprising:
an aligning member having opposing ends;
a pair of supports each configured to support the aligning member at one of the opposing ends thereof; and
a pair of mounts each including a mounting member configured to couple the mount to a structural surface and a support positioner configured to slidably receive and selectively vertically position one of the pair of supports relative to the surface, thereby vertically positioning the aligning member.

11. The apparatus of claim 10, wherein at least one of the pair of support positioners further includes a fastener configured to hold a respective support in a selected vertical position.

12. The apparatus of claim 10, wherein the aligning member further includes a level sensor for indicating a planar orientation of the aligning member.

13. The apparatus of claim 10, wherein each of the pair of supports is pivotably coupled to the aligning member.

14. The apparatus of claim 10, wherein at least one of the opposing ends of the aligning member is configured to engage an adjacent aligning member.

15. The apparatus of claim 14, wherein at least one of the opposing ends of the aligning member further includes a coupling component for removably attaching the adjacent aligning member to the aligning member.

16. The apparatus of claim 10, wherein each of the pair of supports is removably coupled to the aligning member.

17. The apparatus of claim 10, wherein each of the pair of supports further includes a plurality of markers configured to indicate a displacement between successive rows of aligned elements.

18. The apparatus of claim 10, wherein the aligning member comprises one of a metal and an impact-resistant plastic.

19. An apparatus comprising:
an aligning member having opposing ends, the opposing ends each configured to engage an adjacent aligning member;
a level sensor coupled to the aligning member, wherein the level sensor indicates a planar orientation of the aligning member;
a pair of supports each configured to support the aligning member at one of the opposing ends thereof; and
a pair of mounts each including a mounting member configured to couple the mount to a structural surface and a support positioner configured to slidably receive and selectively vertically position one of the pair of supports relative to the surface, thereby vertically positioning the aligning member.

20. The apparatus of claim 19, wherein at least one of the opposing ends of the aligning member further includes a coupling component for removably attaching the adjacent aligning member to the aligning member.
